(19) United States
(12) Patent Application Publication
(10) Pub. No.: US 2026/0247379 A1
(43) Pub. Date: Aug. 20, 2026

(54) METHODS AND APPARATUS TO NEW RADIO BROADCAST RECEPTION

(71) Applicant: Intel Corporation, Santa Clara, CA (US)

(72) Inventors: Avik SENGUPTA, San Jose, CA (US); Debdeep CHATTERJEE, San Jose, CA (US)

(73) Assignee: Intel Corporation, Santa Clara, CA (US)

(21) Appl. No.: 19/641,506

(22) Filed: Apr. 7, 2026

Related U.S. Application Data
(63) Continuation of application No. 18/549,303, filed on Apr. 6, 2022.
(60) Provisional application No. 63/171,530, filed on Apr. 6, 2021.
(60) Provisional application No. 63/187,300, filed on May 11, 2021.

(51) Int. Cl. H04W 72/1273; H04L 1/00; H04W 72/231; H04W 76/20; H04W 76/40

(52) U.S. Cl. CPC H04W 72/1273; H04L 1/0061; H04W 72/231; H04W 76/20; H04W 76/40

(57) ABSTRACT

The disclosure is directed to systems and methods for multicast and broadcast services (MBS) for a wireless network including transmitting to a user equipment (UE) a signaling configuration for reception by the UE of multicast and broadcast services (MBS) in a low quality of service (QoS) multicast or broadcast delivery using an multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying the low QoS or broadcast reception capability of the UE. The method includes monitoring by the UE a physical downlink control channel (PDCCH) cell specific search space (CSS) configured for MBS for the DCI scheduling, the PDSCH carrying the MCCH in the DCI. The PDCCH CSS is configured for a CORESET #0 for the UE in RRC_CONNECTED/IDLE mode, the monitoring in Type0 PDCCH CSS or Type0A PDCCH CSS configured as part of a PDCCH-ConfigCommon configuration.

### CROSS-REFERENCE TO RELATED PATENT APPLICATION(S)

This application is a continuation application of U.S. application Ser. No. 18/549,303, filed Apr. 6, 2022, which is a U.S. National Stage Application under 35 U.S.C. 371 of International Application No. PCT/US2022/023729, filed Apr. 6, 2022, entitled “METHODS AND APPARATUS TO NEW RADIO BROADCAST RECEPTION,” which claims priority to U.S. Provisional Application No. 63/187,300, which was filed May 11, 2021, and to U.S. Provisional Application No. 63/171,530, which was filed Apr. 6, 2021, the entire disclosures of which are hereby incorporated by reference.

### FIELD OF THE DISCLOSURE

This disclosure generally relates to field of wireless communications, and more particularly relates to methods and apparatus related to broadcast and multicast services within a single cell reception by a user equipment (UE) and providing broadcast reception configurations via a multicast control channel (MCCH) carried over a physical downlink shared channel (PDSCH).

### BACKGROUND

The next generation mobile networks, in particular Third Generation Partnership Project (3GPP) systems such as Fifth Generation (5G) and the evolutions thereof, are among the latest cellular wireless technologies developed to deliver ten times faster data rates than LTE and are being deployed with multiple carriers in the same area and across multiple spectrum bands. Resources of a physical network include core network (CN) and radio access network (RAN) resources. Radio network temporary identifiers (RNTIs) are used to identify user equipment (UE) or a group of UEs for 5G gNBs. For broadcasting system information, a system information RNTI may be mapped to a PDSCH physical channel so that all UEs in a cell will know the scheduling for the PDSCH carrying system information. Any necessary scheduling information may be carried in the downlink control information (DCI) which indicates information such as resource configurations and uplink resource grants. There is a need for specialized RNTIs for 5G transmissions.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a wireless network in accordance with an embodiment of the disclosure.

FIG. 2 illustrates an operation flow diagram in accordance with an embodiment of the disclosure.

FIG. 3 illustrates a flow diagram of a method in accordance with an embodiment of the disclosure.

FIG. 4 illustrates an exemplary network in accordance with various embodiments of the disclosure.

FIG. 5 illustrates an exemplary wireless network in accordance with various embodiments of the disclosure.

### DETAILED DESCRIPTION

In terms of a general overview, this disclosure is generally directed to systems and methods for supporting a single cell UE broadcast and multicast services (MBS) and providing broadcast reception configurations for a low quality of service (QoS) via a multicast control channel (MCCH) carried over a physical downlink shared channel (PDSCH).

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

5G networks are becoming increasingly complex with the densification of millimeter wave small cells, and various new services, such as eMBB (enhanced Mobile Broadband), URLLC (Ultra Reliable Low Latency Communications), and mMTC (massive Machine Type Communications) that are characterized by high speed high data volume, low speed ultra-low latency, and infrequent transmitting low data volume from huge number of emerging smart devices, respectively.

As the new 5G services have different characteristics, where there may be different usage pattern in terms of time, location, UE distribution, and types of applications.

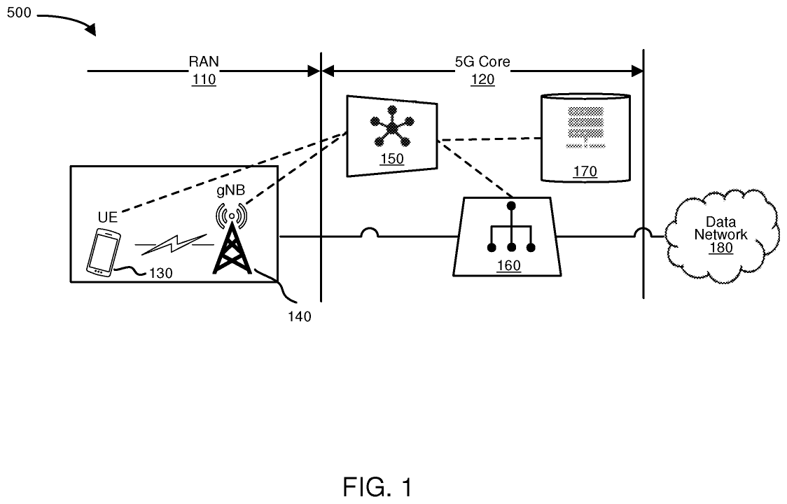

Referring now to FIG. 1, a wireless network 100 illustrates how a radio access network (RAN) is coupled to a 5G Core 120. As shown, user equipment 130 is connected to base station (gNB) 140, which is coupled to access and mobility management function (AMF)/SMF/PCF 150, which is coupled to user plane function (UPF) 160 and application function (AF) 170.

For MBS services to function on a UE, the UE communication exchange between the gNB 140 and the UE 130 establishes capabilities of the UE to enable multicast, broadcast and unicast reception by the UE to establish overall configuration and expected UE behavior. More specifically, a UE may need to be configured to monitor a physical channel, such as a downlink control channel with a DCI that may provide data associated with different applications which have different quality of service requirements, such as multicast, unicast and the like. In 5G applications for New Radio, multicast and unicast transmissions may be combined requiring a UE to receive both multicast and unicast simultaneously, and these requirements are transmitted to the UE in specific search spaces that are monitored by the UE using different radio network temporary identifiers (RNTI) such that a UE may monitor a CORESET in a specific bandwidth part of a received signal for a predetermined set of physical downlink control channel (PDCCH) candidates. As will be appreciated by those of skill in the art, the CRC located in the PDCCH is 16 bits and is scrambled by a radio network temporary identifier (RNTI), which is used by a user equipment (UE). Thus, embodiments described herein relate to physical layer communications between the UE 130, base stations such as gNbs 140, and the 5G core network 120. The communication establishment in accordance with one or more embodiments is generally described in 3GPP NR Rel-17 work related to support of MBS within a single cell mainly targeting groupcast operations for the purpose of critical communications and commercial use cases such as popular video/app downloads.

As will be appreciated by those of skill in the art, MBS allows two main delivery modes, which must be communicated to UE 130. Delivery mode 1 refers to an MBS transmission with high QoS which can be received only by UEs in RRC_CONNECTED mode and delivery mode 2 refers to an MBS transmission with low QoS namely broadcast transmission which can be received by both RRC_CONNECTED and RRC_IDLE/INACTIVE mode UEs. In embodiments, configuration and reception of delivery mode 2 for NR MBS is discussed.

In one or more embodiments, systems and methods, here provide broadcast reception configurations for UE 130 interacting with gNB 140. For example, in one or more embodiments, gNB 140 is configured to transmit to a UE 130 a signaling configuration for reception by UE 130 MBS in a low quality of service (QoS) multicast, or in a broadcast delivery using an multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying reception capability of UE 130. The PDCCH includes information for parsing PDSCH data and transmits information including downlink control information (DCI) used to indicate resource configurations, uplink resource grants of the PDSCH, and the like. The cyclic redundancy check (CRC) is located at the tail of the PDCCH and is 16 bits in length. The CRC is scrambled by using a radio network temporary identifier (RNTI) that identifies a UE in a manner that can allow the UE to communicate in predefined ways. As one of skill in the art will appreciate, UE's perform blind detection on the PDCCH to locate a bit sequence to obtain control signaling and identify different services for the UE and such.

The dedicated RNTI may be group RNTI for identifying multicast or may be an SC-RNTI or a change notification RNTI. Alternatively, the PDSCH may be scheduled by the DCI with an SC-N-RNTI.

In one or more embodiments, broadcast transmission receptions are provided that relate to single cell point to multipoint (SC-PTM) which is described in LTE release 13 which supported both RRC_CONNECTED and RRC_IDLE modes for UEs.

Broadcast transmission reception was supported in LTE Rel-13 using single cell point to multipoint (SC-PTM). Rel-13 SC-PTM supported reception in both RRC_CONNECTED and RRC_IDLE mode. In LTE, MBMS control information including SCPTMConfiguration is obtained from the higher layer logical channel single cell multicast control channel (SC-MCCH) and the SC-PTM traffic is carried in the logical channel single cell multicast traffic channel (SC-MTCH). Both SC-MCCH and SC-MTCH are mapped to PDSCH in the physical layer. The PDSCH carrying SC-MCCH is scheduled by DCI format 1A with CRC scrambled by a single cell (SC)-RNTI and the PDSCH carrying MTCH is scheduled by DCI format 1A with CRC scrambled by the group (G)-RNTI which is provided as a part of the SCPTMConfiguration message. Additionally, configuration change notification is also indicated by PDCCH (without associated PDSCH) using DCI format 1C with CRC scrambled by single cell SC-N-RNTI. Table 1 illustrates LTE based DCI formats and RNTIs for multicast transmissions:

TABLE 1

| | MPDCCH | | | DCI |
|---|---|---|---|---|
| Mode | search space | RNTI | Usage | format |
| Idle | — | SI-RNTI | Broadcast of system | — |
| | | | information | |
| | Type-1A | SC-RNTI | Scheduling of | 6-2 |
| | common | | SC-MCCH | |
| | Type-2A | G-RNTI | Scheduling of | 6-1A, 6-1B |
| | common | | SC-MTCH | |

One common RNTI shown above in Table 1 is the system information RNTI (SI-RNTI) that is used for broadcast of system information. As a common type RNTI it is not allocated for any specific UE and generally is transmitted to all UEs in a common cell.

In one or more embodiments, new radio, 5G MBS transmissions a low quality of service delivery mode, such as delivery mode 2 broadcast is similar to LTE SC-PTM as described above, using MCCH transmitted over a group-common PDSCH in the downlink which is scheduled by PDCCH carrying a DCI 1_0 with CRC scrambled by a dedicated RNTI, for example, a single cell RNTI, SC-RNTI.

In one or more embodiments, the PDCCH can be monitored in a Type0-PDCCH CSS set configured by searchSpaceZero in PDCCH-CommonConfig and associated with a CORESET #0 for both RRC_CONNECTED and IDLE mode UEs.

In one or more embodiments, the PDCCH scheduling the PDSCH carrying the MCCH can be monitored in a Type0A-PDCCH CSS.

In one or more embodiments, UE 130 can be configured with a new PDCCH CSS set, such as mcch-SearchSpace, which is configured by a MBS-specific PDCCH-ConfigCommon or as part of PDCCH-ConfigCommon.

In one or more embodiments, when there is a change in the MBS configurations, UE 130 must be notified by base station 140, and this may be done by a DCI with CRC scrambled with a dedicated RNTI, such as single cell notification RNTI, SC-N-RNTI which is monitored on the same CSS type as the DCI scheduling MCCH for MBS configurations.

In an example, the change notification is included in the DCI without the need for an additional PDSCH containing the MCCH with configuration update. In an alternative example, the DCI with CRC scrambled by the SC-N-RNTI may schedule a PDSCH carrying the updated MCCH configuration scheduled with the same SC-N-RNTI.

In one or more embodiments, if UE 130 receives MBS PDSCH and UE 130 indicated capability for receiving MBS transmission which is frequency domain multiplexed with unicast, in frequency range 1 (FR1), UE 130, may decode a PDSCH scheduled with dynamically scheduled RNTIs, random access response RNTI, C-RNTI, MCS-RNTI, CS-RNTI, RA-RNTI, MsgB-RNTI, or SI-RNTI simultaneously with a PDSCH scheduled with SC-RNTI (carrying MCCH) or SC-N-RNTI (if scheduling of a PDSCH by a PDCCH with CRC scrambled with SC-N-RNTI to indicate MCCH configuration change is supported) that partially or fully overlaps in time in non-overlapping PRBs unless, the PDSCHs scheduled with C-RNTI, CS-RNTI or MCS-RNTI require capability 2 processing time in which case, UE 130 may skip the decoding of PDSCH scheduled with C-RNTI, MCS-RNTI, or CS-RNTI.

In one or more embodiments, for particular frequency bands, such as FR1 bands, UE 130 may be required to receive a PDSCH scheduled with single cell SC-RNTI (carrying MCCH) or SC-N-RNTI when scheduling of PDSCH supported for this SC-N-RNTI, and PDSCH scheduled with C-RNTI, MCS-RNTI, CS-RNTI, RA-RNTI, MsgB-RNTI, or SI-RNTI when configured with minimum UE processing times for PDSCH processing per capability #2.

In one or more embodiments, for FR1 bands, a UE 130 may be required to receive both MBS PDSCH and PDSCH scheduled with C-RNTI, MCS-RNTI, CS-RNTI, RA-RNTI, MsgB-RNTI, or SI-RNTI if the UE 130 is not configured to report HARQ-ACK feedback in response to the MBS PDSCH.

In particular, for FR1 bands, UE 130 may be required to receive both MBS PDSCH and PDSCH scheduled with C-RNTI, MCS-RNTI, CS-RNTI or SI-RNTI, if the MBS PDSCH is scheduled with G-RNTI using delivery mode 2 or SC-RNTI.

In one or more embodiments, for frequency range 2 (FR2), UE 130 may not be expected to simultaneously decode a PDSCH scheduled with C-RNTI, MCS-RNTI, CS-RNTI, RA-RNTI, MsgB-RNTI, or SI-RNTI which overlaps fully or partially in time with a PDSCH carrying MCCH scheduled with SC-RNTI or SC-N-RNTI (if scheduling of PDSCH is supported for this RNTI).

In one or more embodiments, for FR2, for UE 130 is capable of simultaneous reception of MBS and unicast PDSCHs, UE 130 may be expected to simultaneously decode a PDSCH scheduled with C-RNTI, MCS-RNTI, CS-RNTI, RA-RNTI, MsgB-RNTI or SI-RNTI which overlaps fully or partially in time with a PDSCH carrying MCCH scheduled with SC-RNTI or SC-N-RNTI (if scheduling of PDSCH is supported for this RNTI).

In one or more embodiments, on simultaneous reception of time-overlapping PDSCHs in RRC_CONNECTED mode, PDSCH scheduled with SI-RNTI may be limited to processes of P-RNTI triggered system information (SI) acquisition.

In one or more embodiments and examples on simultaneous reception of time-overlapping PDSCHs in RRC_CONNECTED mode, PDSCH scheduled with SC-RNTI may be limited to processes of SC-N-RNTI triggered MCCH acquisition and UE 130 is expected to receive a PDSCH scheduled with C-RNTI, MCS-C-RNTI, CS-RNTI, RA-RNTI, or MsgB-RNTI during a period of autonomous MCCH acquisition.

In one or more embodiments, UE 130 may be in RRC_IDLE and RRC_INACTIVE modes and may be expected to decode two PDSCHs at the same time, each scheduled with SI-RNTI, P-RNTI, RA-RNTI, TC-RNTI, SC-RNTI, G-RNTI, or SC-N-RNTI (if scheduling of PDSCH is supported for this RNTI) and with the two PDSCHs partially or fully overlapping in time in non-overlapping physical resource blocks (PRBs).

In one or more embodiments, when UE 130 receives the PDSCH carrying the MCCH for an MBS configuration scheduled with SC-RNTI or SC-N-RNTI by a DCI monitored in searchSpaceZero or another common search space, the synchronization signal (SS) physical broadcast channel (SS/PBCH) blocks associated with the PDCCH monitoring occasions and the corresponding PDSCHs are pre-configured.

In one or more embodiments, UE 130 may expect the PDCCH and PDSCH DM-RS to be quasi co-located (QCL) with the associated SS/PBCH with respect to Doppler shift, Doppler spread, average delay, delay spread and spatial receiver (RX) parameters when applicable. Alternatively, higher layer signaling may be used to provide a quasi-co-located (QCL) Type A source reference signal (RS) and a QCL Type D source RS through a transmission configuration indicator (TCI) state configuration for an MCCH configuration. The QCL Type A source RS could be a CSI-RS for tracking which is quasi co-located with an SS/PBCH block. For UEs in Idle/Inactive modes, the QCL Type A and Type D sources may correspond directly to an SS/PBCH block. In one or more embodiments, if multiple MCCH configurations are supported, then the QCL assumptions may be configured separately for each MCCH configuration.

In one or more embodiments, if UE 130 is in IDLE/INACTIVE mode, the MCCH may be received within an initial bandwidth part (BWP) if configured or within the bandwidth of the CORESET #0.

In one or more embodiments, the MTCH or the PDSCH carrying the broadcast transmission may be received within a common frequency resource (CFR) which has frequency domain region identical to the initial BWP. In one or more embodiments, a wider CFR can be separately configured by an MBS specific SIB transmission for IDLE/INACTIVE UEs.

In one or more embodiments, the configured CFR may fully contain the CORESET #0 or initial BWP such that common control signaling can be received by UE 130 without a BWP switch. The CFR may be configured on the common resource block (CRB) grid. As one of skill in the art will appreciate, common resource blocks are numbered from 0 and upwards in the frequency domain for each subcarrier spacing. For example, within the 15 kHz, 30 kHz, 60 kHz and 120 kHz bands, there will be CRBs for every subcarrier.

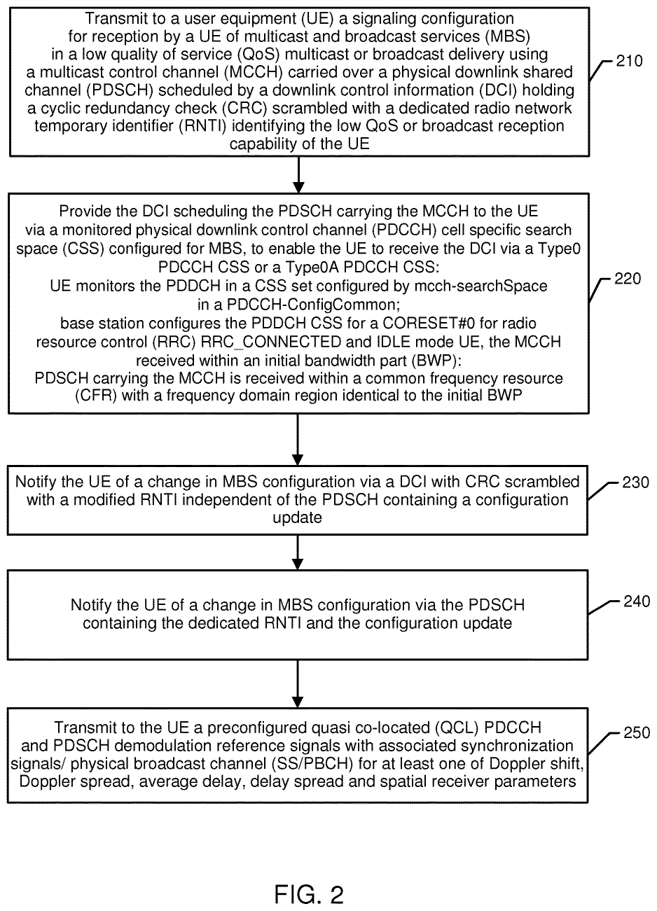

Referring now to FIG. 2, a flow diagram illustrates a method in accordance with an embodiment. More specifically, block 210 provides for transmitting to a user equipment (UE) a signaling configuration for reception by a UE of multicast and broadcast services (MBS) in a low quality of service (QoS) multicast or broadcast delivery using an multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying the low QoS or broadcast reception capability of the UE. For example, UE 130 may receive MBS from a base station 140 transmitting over a physical channel.

Block 220 illustrates providing the DCI scheduling the PDSCH carrying the MCCH to the UE via a monitored physical downlink control channel (PDCCH) cell specific search space (CSS) configured for MBS, to enable the UE to receive the DCI via a Type0 PDCCH CSS or a Type0A PDCCH CSS. For example, base station 140 may provide to UE 130 the DCI scheduling. In one or more embodiments, UE 130 monitors the PDCCH in a CSS set configured by mcch-searchSpace in a PDCCH-ConfigCommon. Further, in one or more embodiments, the base station 140 configures the PDCCH CSS for a CORESET #0 for radio resource control (RRC) RRC_CONNECTED and IDLE mode UE, the MCCH received within an initial bandwidth part (BWP).

Further, in one or more embodiments, the PDSCH carrying the MCCH is received within a common frequency resource (CFR) with a frequency domain region identical to the initial BWP.

Block 230 provides for notifying the UE of a change in MBS configuration via a DCI with CRC scrambled with a modified RNTI independent of the PDSCH containing a configuration update. For example, base station 140 may notify UE 130 of a change in MBS configuration.

Block 240 provides for notifying the UE of a change in MBS configuration via the PDSCH containing the dedicated RNTI and the configuration update. For example, base station 140 may notify UE 130 of a change in MBS using a PDSCH with an RNTI.

Block 250 provides for transmitting to the UE a preconfigured quasi co-located (QCL) PDCCH and PDSCH demodulation reference signals with associated synchronization signals/physical broadcast channel (SS/PBCH) for at least one of Doppler shift, Doppler spread, average delay, delay spread and spatial receiver parameters. For example, base station 140 may transmit to UE 130 a QCL PDCCH and PDSCH reference signal.

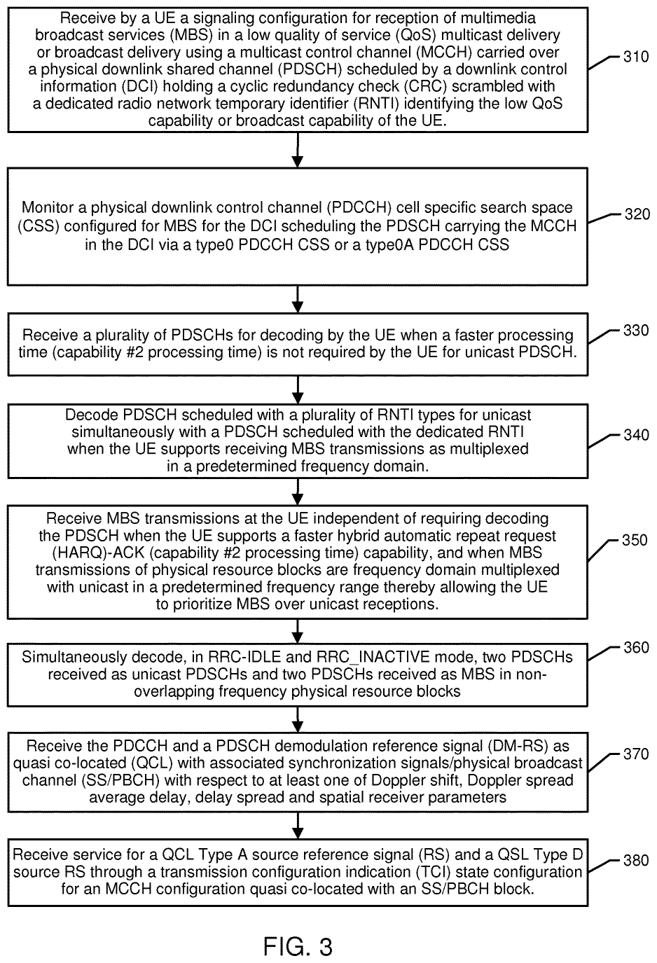

Referring now to FIG. 3, a flow diagram illustrates a method for a UE such as UE 130 receiving MBS transmissions. Block 310 provides for receiving by a UE a signaling configuration for reception of multimedia broadcast services (MBS) in a low quality of service (QoS) multicast delivery or broadcast delivery using a multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying the low QoS capability or broadcast capability of the UE. For example, UE 130 may receive MBS from base station 140 with a low QoS or broadcast data.

Block 320 provides for monitoring a physical downlink control channel (PDCCH) cell specific search space (CSS) configured for MBS for the DCI scheduling the PDSCH carrying the MCCH in the DCI via a type0 PDCCH CSS or a type0A PDCCH CSS. For example, UE 130 may monitor a physical channel for MBS from base station 140.

For example, the UE may monitor an MCCH that provides a mcch-searchSpace configured by an MBS specific PDCCH-ConfigCommon configuration. In one or more embodiments, the PDCCH CSS is configured for a CORESET #0 for RRC_CONNECTED and IDLE mode.

Block 330 provides for receiving a plurality of PDSCHs for decoding by the UE when a faster processing time (capability #2 processing time) is not required by the UE for unicast PDSCH.

Block 340 provides for decoding a PDSCH scheduled with a plurality of RNTI types for unicast simultaneously with a PDSCH scheduled with the dedicated RNTI when the UE supports receiving MBS transmissions as multiplexed in a predetermined frequency domain. For example, UE 130 decodes a PDSCH received from base station 140.

Block 350 provides for receiving MBS transmissions at the UE independent of requiring decoding the PDSCH when the UE supports a faster hybrid automatic repeat request (HARQ)-ACK (capability #2 processing time) capability, and when MBS transmissions of physical resource blocks are frequency domain multiplexed with unicast in a predetermined frequency range thereby allowing the UE to prioritize MBS over unicast receptions. For example UE 130 may receive MBS transmissions without requiring decoding the PDSCH when faster processing times are capable by the UE.

Block 360 provides for simultaneously decoding, in RRC-IDLE and RRC_INACTIVE mode, two PDSCHs received as unicast PDSCHs and two PDSCHs received as MBS in non-overlapping frequency physical resource blocks. For example, UE 130 may simultaneously decode two PDSCHs and two PDSCHs received from one or more base stations 140.

Block 370 provides for receiving the PDCCH and a PDSCH demodulation reference signal (DM-RS) as quasi co-located (QCL) with associated synchronization signals/physical broadcast channel (SS/PBCH) with respect to at least one of Doppler shift, Doppler spread average delay, delay spread and spatial receiver parameters. For example, UE 130 may receive PDCCH and PDSCH signals that are QCL with SS/PBCH.

Block 380 provides for receiving service for a QCL Type A source reference signal (RS) and a QSL Type D source RS through a transmission configuration indication (TCI) state configuration for an MCCH configuration quasi co-located with an SS/PBCH block. For example, UE 130 may receive services for different reference signals of different types.

### Systems and Implementations

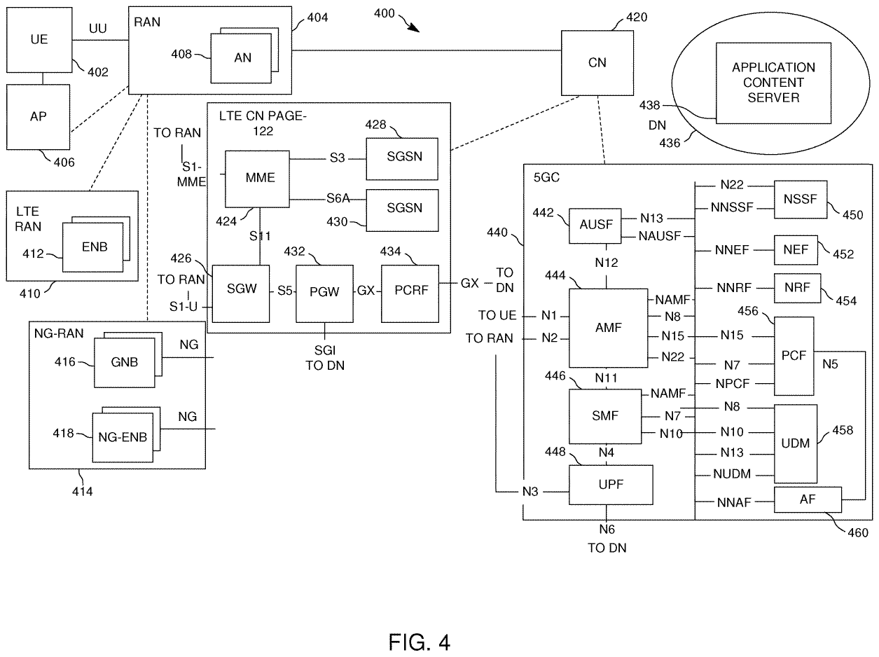

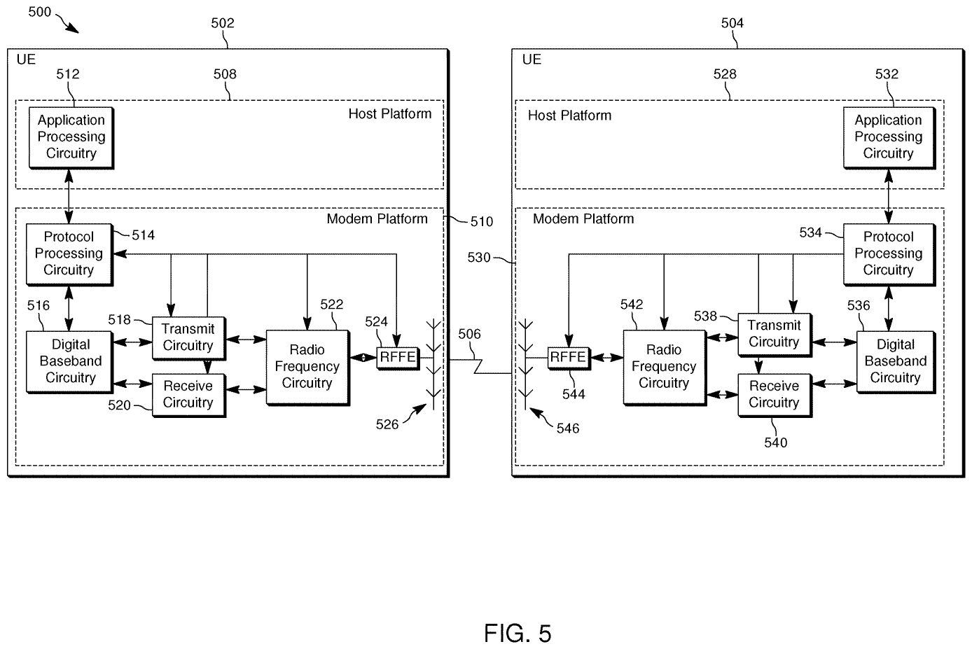

FIGS. 4-5 illustrate various systems, devices, and components that may implement aspects of disclosed embodiments.

FIG. 4 illustrates a network 400 in accordance with various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 may include a UE 402, which may include any mobile or non-mobile computing device designed to communicate with a RAN 404 via an over-the-air connection. The UE 402 may be communicatively coupled with the RAN 404 by a Uu interface. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 402 may additionally communicate with an AP 406 via an over-the-air connection. The AP 406 may manage a WLAN connection, which may serve to offload some/all network traffic from the RAN 404. The connection between the UE 402 and the AP 406 may be consistent with any IEEE 802.11 protocol, wherein the AP 406 could be a wireless fidelity (Wi-Fi®) router. In some embodiments, the UE 402, RAN 404, and AP 406 may utilize cellular-WLAN aggregation (for example, LWA/LWIP). Cellular-WLAN aggregation may involve the UE 402 being configured by the RAN 404 to utilize both cellular radio resources and WLAN resources.

The RAN 404 may include one or more access nodes, for example, AN 408. AN 408 may terminate air-interface protocols for the UE 402 by providing access stratum protocols including RRC, PDCP, RLC, MAC, and LI protocols. In this manner, the AN 408 may enable data/voice connectivity between CN 420 and the UE 402. In some embodiments, the AN 408 may be implemented in a discrete device or as one or more software entities running on server computers as part of, for example, a virtual network, which may be referred to as a CRAN or virtual baseband unit pool. The AN 408 be referred to as a BS, gNB, RAN node, eNB, ng-eNB, NodeB, RSU, TRxP, TRP, etc. The AN 408 may be a macrocell base station or a low power base station for providing femtocells, picocells or other like cells having smaller coverage areas, smaller user capacity, or higher bandwidth compared to macrocells.

In embodiments in which the RAN 404 includes a plurality of ANs, they may be coupled with one another via an X2 interface (if the RAN 404 is an LTE RAN) or an Xn interface (if the RAN 404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs of the RAN 404. For example, the UE 402 and RAN 404 may use carrier aggregation to allow the UE 402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an LTE RAN 410 with eNBs, for example, eNB 412. The LTE RAN 410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an NG-RAN 414 with gNBs, for example, gNB 416, or ng-eNBs, for example, ng-eNB 418. The gNB 416 may connect with 5G-enabled UEs using a 5G NR interface. The gNB 416 may connect with a 5G core through an NG interface, which may include an N2 interface or an N3 interface. The ng-eNB 418 may also connect with the 5G core through an NG interface, but may connect with a UE via an LTE air interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (for example, PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements to provide various functions to support data and telecommunications services to customers/subscribers (for example, users of UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

In some embodiments, the CN 420 may be an LTE CN 422, which may also be referred to as an EPC. The LTE CN 422 may include MME 424, SGW 426, SGSN 428, HSS 430, PGW 432, and PCRF 434 coupled with one another over interfaces (or “reference points”) as shown. Functions of the elements of the LTE CN 422 may be briefly introduced as follows.

The MME 424 may implement mobility management functions to track a current location of the UE 402 to facilitate paging, bearer activation/deactivation, handovers, gateway selection, authentication, etc.

The SGW 426 may terminate an S1 interface toward the RAN and route data packets between the RAN and the LTE CN 422. The SGW 426 may be a local mobility anchor point for inter-RAN node handovers and also may provide an anchor for inter-3GPP mobility. Other responsibilities may include lawful intercept, charging, and some policy enforcement.

The SGSN 428 may track a location of the UE 402 and perform security functions and access control. In addition, the SGSN 428 may perform inter-EPC node signaling for mobility between different RAT networks; PDN and S-GW selection as specified by MME 424; MME selection for handovers; etc. The S3 reference point between the MME 424 and the SGSN 428 may enable user and bearer information exchange for inter-3GPP access network mobility in idle/active states.

The HSS 430 may include a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the LTE CN 420.

The PGW 432 may terminate an SGi interface toward a data network (DN) 436 that may include an application/content server 438. The PGW 432 may route data packets between the LTE CN 422 and the data network 436. The PGW 432 may be coupled with the SGW 426 by an S5 reference point to facilitate user plane tunneling and tunnel management. The PGW 432 may further include a node for policy enforcement and charging data collection (for example, PCEF). Additionally, the SGi reference point between the PGW 432 and the data network 436 may be an operator external public, a private PDN, or an intra-operator packet data network, for example, for provision of IMS services. The PGW 432 may be coupled with a PCRF 434 via a Gx reference point.

The PCRF 434 is the policy and charging control element of the LTE CN 422. The PCRF 434 may be communicatively coupled to the app/content server 438 to determine appropriate QoS and charging parameters for service flows. The PCRF 432 may provision associated rules into a PCEF (via Gx reference point) with appropriate TFT and QCI.

In some embodiments, the CN 420 may be a 5GC 440. The 5GC 440 may include an AUSF 442, AMF 444, SMF 446, UPF 448, NSSF 450, NEF 452, NRF 454, PCF 456, UDM 458, and AF 460 coupled with one another over interfaces (or “reference points”) as shown. Functions of the elements of the 5GC 440 may be briefly introduced as follows.

The AUSF 442 may store data for authentication of UE 402 and handle authentication-related functionality. The AUSF 442 may facilitate a common authentication framework for various access types. In addition to communicating with other elements of the 5GC 440 over reference points as shown, the AUSF 442 may exhibit an Nausf service-based interface.

The AMF 444 may allow other functions of the 5GC 440 to communicate with the UE 402 and the RAN 404 and to subscribe to notifications about mobility events with respect to the UE 402. The AMF 444 may be responsible for registration management (for example, for registering UE 402), connection management, reachability management, mobility management, lawful interception of AMF-related events, and access authentication and authorization. The AMF 444 may provide transport for SM messages between the UE 402 and the SMF 446, and act as a transparent proxy for routing SM messages. AMF 444 may also provide transport for SMS messages between UE 402 and an SMSF. AMF 444 may interact with the AUSF 442 and the UE 402 to perform various security anchor and context management functions. Furthermore, AMF 444 may be a termination point of a RAN CP interface, which may include or be an N2 reference point between the RAN 404 and the AMF 444; and the AMF 444 may be a termination point of NAS (N1) signaling, and perform NAS ciphering and integrity protection. AMF 444 may also support NAS signaling with the UE 402 over an N3 IWF interface.

The SMF 446 may be responsible for SM (for example, session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 444 over N2 to AN 408; and determining SSC mode of a session. SM may refer to management of a PDU session, and a PDU session or “session” may refer to a PDU connectivity service that provides or enables the exchange of PDUs between the UE 402 and the data network 436.

The UPF 448 may act as an anchor point for intra-RAT and inter-RAT mobility, an external PDU session point of interconnect to data network 436, and a branching point to support multi-homed PDU session. The UPF 448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 448 may include an uplink classifier to support routing traffic flows to a data network.

The NSSF 450 may select a set of network slice instances serving the UE 402. The NSSF 450 may also determine allowed NSSAI and the mapping to the subscribed S-NSSAIs, if needed. The NSSF 450 may also determine the AMF set to be used to serve the UE 402, or a list of candidate AMFs based on a suitable configuration and possibly by querying the NRF 454. The selection of a set of network slice instances for the UE 402 may be triggered by the AMF 444 with which the UE 402 is registered by interacting with the NSSF 450, which may lead to a change of AMF. The NSSF 450 may interact with the AMF 444 via an N22 reference point; and may communicate with another NSSF in a visited network via an N31 reference point (not shown). Additionally, the NSSF 450 may exhibit an Nnssf service-based interface.

The NEF 452 may securely expose services and capabilities provided by 3GPP network functions for third party, internal exposure/re-exposure, AFs (e.g., AF 460), edge computing or fog computing systems, etc. In such embodiments, the NEF 452 may authenticate, authorize, or throttle the AFs. NEF 452 may also translate information exchanged with the AF 460 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. Additionally, the NEF 452 may exhibit an Nnef service-based interface.

The NRF 454 may support service discovery functions, receive NF discovery requests from NF instances, and provide the information of the discovered NF instances to the NF instances. NRF 454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 454 may exhibit the Nnrf service-based interface.

The PCF 456 may provide policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 may handle subscription-related information to support the network entities' handling of communication sessions, and may store subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR 221 to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

The AF 460 may provide application influence on traffic routing, provide access to NEF, and interact with the policy framework for policy control.

In some embodiments, the 5GC 440 may enable edge computing by selecting operator/3rd party services to be geographically close to a point that the UE 402 is attached to the network. This may reduce latency and load on the network. To provide edge-computing implementations, the 5GC 440 may select a UPF 448 close to the UE 402 and execute traffic steering from the UPF 448 to data network 436 via the N6 interface. This may be based on the UE subscription data, UE location, and information provided by the AF 460. In this way, the AF 460 may influence UPF (re) selection and traffic routing. Based on operator deployment, when AF 460 is considered to be a trusted entity, the network operator may permit AF 460 to interact directly with relevant NFs. Additionally, the AF 460 may exhibit an Naf service-based interface.

The data network 436 may represent various network operator services, Internet access, or third party services that may be provided by one or more servers including, for example, application/content server 438.

Referring now to FIG. 5, a schematic illustrates a wireless network 500 in accordance with various embodiments. The wireless network 500 may include a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mmWave or sub-6 GHZ frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations.

The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mm Wave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include a device comprising processing circuitry coupled to storage, the processing circuitry configured to: transmit to a user equipment (UE) a signaling configuration for reception by the UE of multicast and broadcast services (MBS) in a low quality of service (QoS) multicast or broadcast delivery using an multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying the low QoS or broadcast reception capability of the UE.

Example 2 may include the device of example 1 and/or some other example herein, wherein the processing circuitry may be further configured to: provide the DCI scheduling the PDSCH carrying the MCCH to the UE via a monitored physical downlink control channel (PDCCH) cell specific search space (CSS) configured for MBS, to enable the UE to receive the DCI via a Type0 PDCCH CSS or a Type0A PDCCH CSS.

Example 3 may include the device of example 2 and/or some other example herein, wherein the PDCCH may be monitored in a CSS set configured by mcch-searchSpace in a PDCCH-ConfigCommon.

Example 4 may include the device of example 2 and/or some other example herein, wherein the PDCCH CSS may be configured for a CORESET #0 for radio resource control (RRC) RRC_CONNECTED and IDLE mode UE, the MCCH received within an initial bandwidth part (BWP).

Example 5 may include the device of example 4 and/or some other example herein, wherein the PDSCH carrying the MCCH may be received within a common frequency resource (CFR) with a frequency domain region identical to the initial BWP.

Example 6 may include the device of example 1 and/or some other example herein, wherein the processing circuitry may be further configured to: notify the UE of a change in MBS configuration via a DCI with CRC scrambled with a modified RNTI independent of the PDSCH containing a configuration update.

Example 7 may include the device of example 1 and/or some other example herein, wherein the processing circuitry may be further configured to: notify the UE of a change in MBS configuration via the PDSCH containing the dedicated RNTI and the configuration update.

Example 8 may include the device of example 1 and/or some other example herein, wherein the processing circuitry may be further configured to: transmit to the UE a preconfigured quasi co-located (QCL) PDCCH and PDSCH demodulation reference signals with associated synchronization signals/physical broadcast channel (SS/PBCH) for at least one of Doppler shift, Doppler spread, average delay, delay spread and spatial receiver parameters.

Example 9 may include a non-transitory computer-readable medium storing computer-executable instructions which when executed by one or more processors result in performing operations comprising: receive a signaling configuration for reception of multimedia broadcast services (MBS) in a low quality of service (QoS) multicast delivery or broadcast delivery using a multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying the low QoS capability or broadcast capability of the UE.

Example 10 may include the non-transitory computer-readable medium of example 9 and/or some other example herein, wherein the operations further comprise: monitoring a physical downlink control channel (PDCCH) cell specific search space (CSS) configured for MBS for the DCI scheduling the PDSCH carrying the MCCH in the DCI via a type0 PDCCH CSS or a type0A PDCCH CSS.

Example 11 may include the non-transitory computer-readable medium of example 9 and/or some other example herein, wherein MCCH provides a mcch-searchSpace configured by an MBS specific PDCCH-ConfigCommon configuration.

Example 12 may include the apparatus of example 10 and/or some other example herein, wherein the PDCCH CSS may be configured for a CORESET #0 for RRC_CONNECTED and IDLE mode.

Example 13 may include the non-transitory computer-readable medium of example 10 and/or some other example herein, wherein the operations further comprise: receiving a plurality of PDSCHs for decoding by the UE when a faster processing time (capability #2 processing time) may be not required by the UE for unicast PDSCH.

Example 14 may include the non-transitory computer-readable medium of example 10 and/or some other example herein, wherein the operations further comprise: decoding a PDSCH scheduled with a plurality of RNTI types for unicast simultaneously with a PDSCH scheduled with the dedicated RNTI when the UE supports receiving MBS transmissions as multiplexed in a predetermined frequency domain.

Example 15 may include the non-transitory computer-readable medium of example 10 and/or some other example herein, wherein the operations further comprise: receiving MBS transmissions at the UE independent of requiring decoding the PDSCH when the UE supports a faster hybrid automatic repeat request (HARQ)-ACK (capability #2 processing time) capability, and when MBS transmissions of physical resource blocks (PRBs) are frequency domain multiplexed with unicast in a predetermined frequency range thereby allowing the UE to prioritize MBS over unicast receptions.

Example 16 may include the non-transitory computer-readable medium of example 10 and/or some other example herein, wherein the operations further comprise: simultaneously decoding, in RRC-IDLE and RRC_INACTIVE mode, two PDSCHs received as unicast PDSCHs and two PDSCHs received as MBS in non-overlapping frequency physical resource blocks (PRBs).

Example 17 may include the non-transitory computer-readable medium of example 16 and/or some other example herein, wherein the operations further comprise: receiving the PDCCH and a PDSCH demodulation reference signal (DM-RS) as quasi co-located (QCL) with associated synchronization signals/physical broadcast channel (SS/PBCH) with respect to at least one of Doppler shift, Doppler spread average delay, delay spread and spatial receiver parameters.

Example 18 may include the non-transitory computer-readable medium of example 17 and/or some other example herein, wherein the operations further comprise: receiving service for a QCL Type A source reference signal (RS) and a QSL Type D source RS through a transmission configuration indication (TCI) state configuration for an MCCH configuration quasi co-located with an SS/PBCH block.

Example 19 may include a method comprising: receiving at the UE a signaling configuration for reception of multicast and broadcast services (MBS) using a multicast control channel (MCCH) carried over a physical downlink shared channel (PDSCH) scheduled by a downlink control information (DCI) holding a cyclic redundancy check (CRC) scrambled with a dedicated radio network temporary identifier (RNTI) identifying the broadcast reception abilities of the UE; and monitoring by the UE a physical downlink control channel (PDCCH) cell specific search space (CSS) configured for MBS for the DCI scheduling, the PDSCH carrying the MCCH in the DCI.

Example 20 may include the method of example 19 and/or some other example herein, wherein the PDCCH CSS may be configured for a CORESET #0 for the UE in RRC_CONNECTED and IDLE mode, the monitoring in Type0 PDCCH CSS or Type0A PDCCH CSS configured as part of a PDCCH-ConfigCommon configuration.

Example 21 may include the method of example 19 and/or some other example herein, further comprising: decoding a plurality of PDSCHs multiplexed in a frequency domain when a faster processing capability (capability #2 processing time) may be not required for the UE to receive unicast PDSCH transmissions.

Example 22 may include the method of example 19 and/or some other example herein, further comprising: decoding a PDSCH scheduled with a plurality of RNTI types for unicast simultaneously with a PDSCH scheduled with the dedicated RNTI when the UE supports receiving PDSCH MBS transmissions as multiplexed in a predetermined frequency domain when the UE has a faster processing capability (capability #2 processing time).

Example 23 may include the method of example 19 and/or some other example herein, further comprising: receiving MBS transmissions at the UE independent of requiring decoding the PDSCH when the UE supports a faster hybrid automatic repeat request (HARQ)-ACK (capability #2 processing time) capability, and when MBS transmissions of physical resource blocks (PRBs) are frequency domain multiplexed with unicast in a predetermined frequency range thereby allowing the UE to prioritize MBS over unicast receptions.

Example 24 may include the method of example 19 and/or some other example herein, further comprising: simultaneously decoding, in RRC-IDLE and RRC_INACTIVE mode, two PDSCHs received as unicast PDSCHs and two PDSCHs received as MBS in non-overlapping frequency physical resource blocks (PRBs).

Example 25 may include the method of example 19 and/or some other example herein, further comprising: receiving the PDCCH and a PDSCH demodulation reference signal (DM-RS) as quasi co-located (QCL) with associated synchronization signals/physical broadcast channel (SS/PBCH) with respect to at least one of Doppler shift, Doppler spread average delay, delay spread and spatial receiver parameters.

Example 26 may include an apparatus comprising means for performing any of the methods of examples 1-25.

Example 27 may include a network node comprising a communication interface and processing circuitry connected thereto and configured to perform the methods of examples 1-25.

Example 28 may include an apparatus comprising means to perform one or more elements of a method described in or related to any of examples 1-25, or any other method or process described herein.

Example 29 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example 30 may include an apparatus comprising logic, modules, or circuitry to perform one or more elements of a method described in or related to any of examples 1-25, or any other method or process described herein.

Example 31 may include a method, technique, or process as described in or related to any of examples 1-25, or portions or parts thereof.

Example 32 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example 33 may include a signal as described in or related to any of examples 1-25, or portions or parts thereof.

Example 34 may include a datagram, packet, frame, segment, protocol data unit (PDU), or message as described in or related to any of examples 1-25, or portions or parts thereof, or otherwise described in the present disclosure.

Example 35 may include a signal encoded with data as described in or related to any of examples 1-25, or portions or parts thereof, or otherwise described in the present disclosure.

Example 34 may include a signal encoded with a datagram, packet, frame, segment, protocol data unit (PDU), or message as described in or related to any of examples 1-25, or portions or parts thereof, or otherwise described in the present disclosure.

Example 36 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example 37 may include a computer program comprising instructions, wherein execution of the program by a processing element is to cause the processing element to carry out the method, techniques, or process as described in or related to any of examples 1-25, or portions thereof.

Example 38 may include a signal in a wireless network as shown and described herein.

Example 39 may include a method of communicating in a wireless network as shown and described herein.

Example 40 may include a system for providing wireless communication as shown and described herein.

Example 41 may include a device for providing wireless communication as shown and described herein.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

TABLE 1
Abbreviations:

| 3GPP | Third Generation |
|---|---|
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access |
| | Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote |
| | Access Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway |
| | Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management |
| | System |
| CO | Conditional Optional |
| CoMP | Coordinated Multi-Point |
| CORESET | Control Resource Set |
| COTS | Commercial Off-The- |
| | Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, |
| | Central Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI- |
| | RS Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference |
| | Signal |
| DRX | Discontinuous Reception |
| DSL | Domain Specific |
| | Language. Digital |
| | Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | tableManagement |
| | Function |
| EGPRS | Enhanced GPRS |
| EIR | Equipment Identity |
| | Register |
| eLAA | enhanced Licensed |
| | Assisted Access, enhanced |
| | LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CU | gNB-centralized unit, Next |
| | Generation NodeB |
| | centralized unit |
| gNB-DU | gNB-distributed unit, Next |
| | Generation NodeB |
| | distributed unit |
| GNSS | Global Navigation |
| | Satellite System |
| GPRS | General Packet Radio |
| | Service |
| GPSI | Generic Public |
| | Subscription Identifier |
| GSM | Global System for Mobile |
| | Communications, Groupe |
| | Spécial Mobile |
| GTP | GPRS Tunneling Protocol |
| GTP-U | GPRS Tunnelling Protocol |
| | for User Plane |
| GTS | Go To Sleep Signal |
| | (related to WUS) |
| GUMMEI | Globally Unique |
| | MME Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence |
| | Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| Constraint length of the | |
| convolutional code, USIM | |
| Individual key | |
| kB | Kilobyte (1000 bytes) |
| kbps | kilo-bits per second |
| Kc | Ciphering key |
| Ki | Individual subscriber |
| | authentication |
| | key |
| KPI | Key Performance |
| | Indicator |
| KQI | Key Quality Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 reference |
| | signal received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access |
| | Control (protocol |
| | layering context) |
| MAC | Message authentication |
| | code (security/encryption |
| | context) |
| MAC-A | MAC used for |
| | authentication and key |
| | agreement (TSG T |
| | WG3 context) |
| MAC-I | MAC used for data |
| | integrity of signalling |
| | messages (TSG T |
| | WG3 context) |
| MANO | Management and |
| | Orchestration |
| MBMS | Multimedia Broadcast |
| | and Multicast Service |
| MBSFN | Multimedia Broadcast |
| | multicast service |
| | Single Frequency |
| | Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical |
| | Random Access |
| | CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification Number |
| MSISDN | Mobile Subscriber |
| | ISDN Number |
| MT | Mobile Terminated, |
| | Mobile |
| | Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA-NR |
| | Dual Connectivity |
| NM | Network Manager |
| NMS | Network Management |
| | System |
| N-PoP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared |
| | CHannel |
| NPSS | Narrowband Primary |
| | Synchronization |
| | Signal |
| NSSS | Narrowband |
| | Secondary |
| | Synchronization Signal |
| NR | New Radio, Neighbour |
| | Relation |
| NRF | NF Repository |
| | Function |
| NRS | Narrowband Reference |
| | Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single-NSSAI |
| NSSF | Network Slice |
| | Selection Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit—type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average Ratio |
| PBCH | Physical Broadcast |
| | Channel |
| PC | Power Control, |
| | Personal Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control |
| | Function |
| PCRF | Policy Control and |
| | Charging Rules |
| | Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow |
| | Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning Reference |
| | Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS |
| | Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access |
| | Channel |
| RADIUS | Remote Authentication |
| | Dial In User Service |
| RAN | Radio Access Network |
| RAND | RANDom number |
| | (used for |
| | authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC AM | RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MMES1 | for the control plane |
| S1-U | S1 for the user plane |
| S-GW | Serving Gateway |
| S-RNTI | SRNC Radio Network |
| | Temporary Identity |
| S-TMSI | SAE Temporary |
| | Mobile Station |
| | Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation Protocol |
| | layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| | Control |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access Network |
| UwPTS | Uplink Pilot Time Slot |
| V2I | Vehicle-to- |
| | Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding |
| | Graph |
| VNFFGD | VNF Forwarding |
| | Graph Descriptor |
| VNFM | VNF Manager |
| VoIP | Voice-over-IP, Voice- |
| | over-Internet Protocol |
| VPLMN | Visited Public Land |
| | Mobile Network |
| VPN | Virtual Private |
| | Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | exclusive OR |
| ZC | Zadoff-Chu |
| ZP | Zero Po |

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” “example implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, nomadic devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. An apparatus for a user equipment (UE), the apparatus comprising:
processing circuitry configured to:
monitor downlink control information (DCI) having a cyclic redundancy check (CRC) scrambled with a multicast/broadcast radio network temporary identifier (RNTI);
detect a physical downlink shared channel (PDSCH) carrying multicast/broadcast service (MBS) information in a time interval as at least one other PDSCH scheduled with a unicast or RNTI;
determine, based on a frequency range and a capability of the UE, whether decoding of the PDSCH carrying the MBS information and the at least one other PDSCH is required; and
receive the PDSCH carrying the MBS information within a common frequency resource configured for MBS reception; and
a memory to store the MBS information.

2. The apparatus of claim 1, wherein the multicast/broadcast RNTI comprises at least one of a single-cell RNTI (SC-RNTI), a group RNTI (G-RNTI), or a single-cell notification RNTI (SC-N-RNTI).

3. The apparatus of claim 1, wherein the processing circuitry is further configured to decode, for frequency range 1 (FR1), the PDSCH carrying the MBS information and the at least one other PDSCH.

4. The apparatus of claim 3, wherein the processing circuitry is further configured to cause to skip decoding of the at least one other PDSCH when decoding of the at least one other PDSCH based on a capability 2 processing time.

5. The apparatus of claim 1, wherein, for frequency range 2 (FR2), the processing circuitry is further configured to not expect decoding of the PDSCH carrying the MBS information and the at least one other PDSCH unless support is indicated for simultaneous multicast/broadcast and unicast reception.

6. The apparatus of claim 1, wherein the at least one other PDSCH is scheduled with at least one of a cell RNTI (C-RNTI), system information RNTI (SI-RNTI), random access RNTI (RA-RNTI), message-B RNTI (MsgB-RNTI), or paging RNTI (P-RNTI).

7. The apparatus of claim 1, wherein the common frequency resource is associated with an initial bandwidth part of the UE.

8. The apparatus of claim 1, wherein the processing circuitry is further configured to receive two PDSCHs each scheduled with respective RNTIs.

9. The apparatus of claim 8, wherein the two PDSCHs are partially or fully overlapping in time and occupying non-overlapping physical resource blocks.

10. A non-transitory computer-readable medium storing computer-executable instructions which when executed by one or more processors result in performing operations comprising:
monitoring downlink control information (DCI) having a cyclic redundancy check (CRC) scrambled with a multicast/broadcast radio network temporary identifier (RNTI);
detecting a physical downlink shared channel (PDSCH) carrying multicast/broadcast service (MBS) information in a time interval as at least one other PDSCH scheduled with a unicast or RNTI;
determining, based on a frequency range and a capability of the UE, whether decoding of the PDSCH carrying the MBS information and the at least one other PDSCH is required; and
receiving the PDSCH carrying the MBS information within a common frequency resource configured for MBS reception.

11. The non-transitory computer-readable medium of claim 10, wherein the multicast/broadcast RNTI comprises at least one of a single-cell RNTI (SC-RNTI), a group RNTI (G-RNTI), or a single-cell notification RNTI (SC-N-RNTI).

12. The non-transitory computer-readable medium of claim 10, wherein the operations further comprise decoding, for frequency range 1 (FR1), the PDSCH carrying the MBS information and the at least one other PDSCH.

13. The non-transitory computer-readable medium of claim 10, wherein the operations further comprise causing to skip decoding of the at least one other PDSCH when decoding of the at least one other PDSCH based on a capability 2 processing time.

14. The non-transitory computer-readable medium of claim 10, wherein, for frequency range 2 (FR2), the operations further comprise not expecting decoding of the PDSCH carrying the MBS information and the at least one other PDSCH unless support is indicated for simultaneous multicast/broadcast and unicast reception.

15. The non-transitory computer-readable medium of claim 10, wherein the at least one other PDSCH is scheduled with at least one of a cell RNTI (C-RNTI), system information RNTI (SI-RNTI), random access RNTI (RA-RNTI), message-B RNTI (MsgB-RNTI), or paging RNTI (P-RNTI).

16. The non-transitory computer-readable medium of claim 10, wherein the common frequency resource is associated with an initial bandwidth part of the UE.

17. The non-transitory computer-readable medium of claim 10, wherein the operations further comprise receiving two PDSCHs each scheduled with respective RNTIs.

18. The non-transitory computer-readable medium of claim 17, wherein the two PDSCHs are partially or fully overlapping in time and occupying non-overlapping physical resource blocks.

19. A method comprising:
monitoring downlink control information (DCI) having a cyclic redundancy check (CRC) scrambled with a multicast/broadcast radio network temporary identifier (RNTI);
detecting a physical downlink shared channel (PDSCH) carrying multicast/broadcast service (MBS) information in a time interval as at least one other PDSCH scheduled with a unicast or RNTI;
determining, based on a frequency range and a capability of the UE, whether decoding of the PDSCH carrying the MBS information and the at least one other PDSCH is required; and
receiving the PDSCH carrying the MBS information within a common frequency resource configured for MBS reception.

20. The method of claim 19, wherein the multicast/broadcast RNTI comprises at least one of a single-cell RNTI (SC-RNTI), a group RNTI (G-RNTI), or a single-cell notification RNTI (SC-N-RNTI).
